(19) United States
(12) Patent Application Publication
(10) Pub. No.: US 2023/0237301 A1
(43) Pub. Date: Jul. 27, 2023

(54) APPARATUS FOR SECURING AND STORING PAYMENT CARD

(71) Applicant: Jack Leonard, Plano, TX (US)

(72) Inventor: Jack Leonard, Plano, TX (US)

(21) Appl. No.: 18/150,956

(22) Filed: Jan. 6, 2023

Related U.S. Application Data
(60) Provisional application No. 63/297,742, filed on Jan. 8, 2022.

(51) Int. Cl. G06K 19/073

(52) U.S. Cl. CPC G06K 19/07327

(57) ABSTRACT

An apparatus for securing and storing a payment card having a hollow container body with a back side for mounting to a vehicle. A lockable door attached to the front of the container body provides controlled access by a user to an interior chamber within the container body, said interior chamber serving as a secure compartment for storing a payment card. A retractable tether line couples the payment card to the interior chamber of the container body. A retractable spool that is biased to retract the tether line is mounted within a spool housing. The spool housing may be attached to the interior chamber or alternatively, to a proximal end of the payment card. A user-actuated trigger is attached to the spool housing and is configured to allow a user to apply tension to the tether line to halt the extension and retraction of the tether line.

### CROSS REFERENCE TO RELATED APPLICATIONS

This application claims priority to Provisional Pat. Application No. 63/297,742, filed Jan. 8, 2022, and titled “Apparatus for Securing and Storing Payment Card,” which is hereby incorporated by reference in its entirety.

### BACKGROUND OF THE INVENTION

### Technical Field

The present invention relates generally to apparatuses for securing and storing objects, and more particularly, to an apparatus for securing and storing a payment card, said apparatus in at least one embodiment being mounted to the exterior of a vehicle and having a user-actuated retractable tether that couples the apparatus and the payment card.

### Description of Related Art

Various types of payment cards (credit cards, debit cards, fuel cards) are provided to employees and independent contractors tasked with driving vehicles. Such payment cards are typically provided only for completing payment transactions for fuel. However, one problem that has arisen with the provision of such payment cards to drivers is that the payment cards can be and are often used in an unauthorized manner. Namely, to pay for non-fuel goods and services that have not been authorized for payment by the provider of the payment card. The ability of drivers to use payment cards for unauthorized goods and services results in monetary losses to the payment card provider. While issuers of certain payment cards may be able to utilize software means to block certain non-fuel transactions from being authorized, the fees paid to enable such features, or to use cards capable of utilizing such features, may be cost prohibitive. Instead, there exists a need for a more simple, cost-effective means for securing and storing a payment card to prevent such unauthorized non-fuel transactions.

The means utilized in the prior art for the coupling/tethering of items to a secured compartment/container suffer numerous drawbacks, especially were such means to be utilized in conjunction with a payment card. For example, the use of non-retracting tethers used to couple items to a secured compartment often results in an unwanted excess length of tether line that often becomes tangled, knotted, or potentially snagged on other items. Further, automatically retracting tethers require a user to maintain tension on the tethered item to keep such item from being retracted back into the secured compartment. Having to maintain such tension on a payment card, which in many cases must be inserted into a reader for a period of time, can be inconvenient for a user that may want to attend to other tasks such as pumping gas, cleaning windows, engaging in communications, etc.

Therefore, what is needed is a more simple, cost-effective means for securing and storing a payment card to prevent unauthorized non-fuel transactions. What is also needed is a system for tethering a payment card to a secure compartment/container in a way that allows for a user to control the extension and retraction of a tether line. These and other needs are met by the embodiments of the apparatus for securing and storing a payment card described below with reference to the accompanying drawings.

### BRIEF DESCRIPTION OF THE SEVERAL VIEWS OF THE DRAWINGS

The invention will be more fully understood by reference to the following detailed description of the preferred and alternate embodiments when read in conjunction with the accompanying drawings, wherein:

FIG. 1 shows a front view of an embodiment of an apparatus for securing and storing a payment card mounted onto an exterior side of a vehicle;

FIG. 2 shows a front view of the embodiment of an apparatus for securing and storing a payment card depicted in FIG. 1, said apparatus being in a close configuration;

FIG. 3 shows a perspective view of an embodiment of an apparatus for securing and storing a payment card depicted in FIG. 1, said apparatus being in an open configuration;

FIG. 4 shows a perspective view of components of the embodiment of an apparatus for securing and storing a payment card depicted in FIG. 3;

FIG. 5 shows a perspective view of an embodiment of an apparatus for securing and storing a payment card depicted in FIG. 1, said apparatus being in an open configuration, and having a payment card connected to said apparatus;

FIG. 6 shows a perspective view of an alternate embodiment of an apparatus for securing and storing a payment card depicted in FIG. 5, said apparatus being in electronic communication with a network to provide an alert if said payment card moves beyond a predetermined distance from said apparatus; and

FIG. 7 shows a perspective view of a further alternate embodiment of an apparatus for securing and storing a payment card depicted in FIG. 5.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF EMBODIMENTS OF THE INVENTION

Several exemplary embodiments of the claimed invention(s) will now be described with reference to the drawings. Unless otherwise noted, like elements will be identified by identical numbers throughout all figures. The invention(s) illustratively disclosed herein suitably may be practiced in the absence of any element that is not specifically disclosed herein. The following description is not to be taken in a limiting sense, but is made merely for the purpose of describing the general principles of exemplary embodiments. The scope of the invention(s) should be determined with reference to the claims (if recited herein). Reference throughout this specification to “one embodiment,” “an embodiment,” or similar language means that a particular feature, structure, or characteristic described in connection with the embodiment is included in at least one embodiment of the inventions disclosed herein. Thus, appearances of the phrases “in one embodiment,” “in an embodiment,” and similar language throughout this specification may, but do not necessarily, all refer to the same embodiment. Furthermore, the described features, structures, or characteristics of the invention may be combined in any suitable manner in one or more embodiments. In the following description, numerous specific details are provided, such as examples of device structures, methods of use of the devices, etc., to provide a thorough understanding of embodiments of the invention(s). One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention(s).

A novel apparatus for securing and storing a payment card is disclosed herein. It should be noted that while the exemplary embodiments of the inventions as described herein are associated with payment cards for use primarily in connection with the payment of fuel for fleet vehicles, the same principles discussed herein could be implemented in connection with apparatuses for securing and storing other types of means for payment, and also for use in connection with payment transactions for all types of goods and services. It should also be noted that while the exemplary embodiments of the inventions as described herein are configured primarily for the mounting on a fuel powered motorized vehicle, it is also contemplated that such inventions may likewise be mounted on electric vehicles, non-vehicles, structures, user-wearable devices, and all manner of other objects.

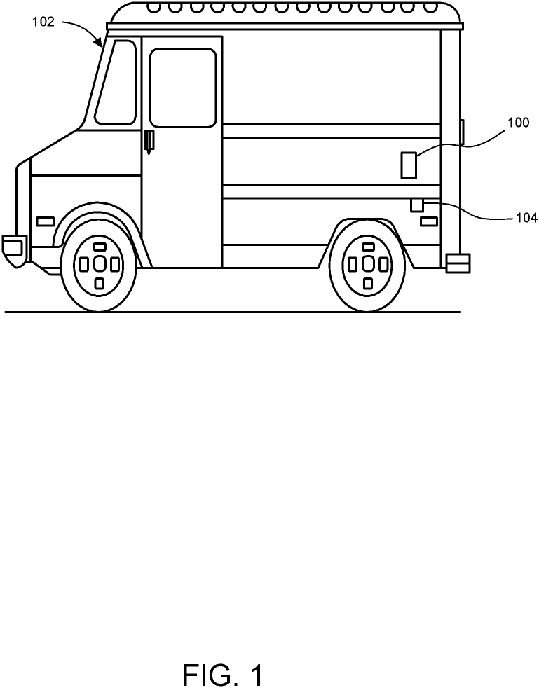

Referring now to FIG. 1, shown is a front view of an embodiment of an apparatus container body (100) for securing and storing a payment card mounted onto an exterior side of a vehicle (102). In one embodiment, the apparatus for securing and storing a payment card is a user-accessible secure container body (100) such as a lock box having a rear side for mounting to a vehicle such as, for example, a truck (102). As discussed further herein, the apparatus container body also in one embodiment has a front side that in one embodiment comprises an access door hingedly attached to a bottom side of the apparatus container body, said access door having a locking mechanism by which a user can secure closure of the access door, and also open the access door when desired (for example, when the user needs to use the payment card to complete a fuel transaction). The apparatus container body in one embodiment is hollow, having an interior chamber in which a spool having a retractable tether cord/line is mounted, a distal end of said cord/line being attached to a payment card such that the payment card can only be used within a predetermined distance (the maximum length of the cord) from the apparatus.

Still referring to FIG. 1, in one embodiment the apparatus is mounted on a location of the vehicle that is adjacent to the opening of the vehicle’s fuel tank (104). While the apparatus container body (100) can be located on any surface of the exterior or interior of the vehicle, it is contemplated that the apparatus container body be mounted at a place on the vehicle that will be adjacent to a fuel pump when a user is refueling the vehicle to which the apparatus is mounted. Mounting the apparatus container body at such a location on a vehicle will ensure that a user is capable of moving the payment card so that it can reach a payment card reader at the fuel pump (in other words, so that the cord/line to which the payment card is attached does not reach it maximum extended length before the payment card can reach the card reader). This presents an advantage over the prior art containment systems in that the apparatus provides a solution for securing and storing a payment card that simultaneously allows for authorized use of the payment card for a fuel transaction, while also physically limiting use of the card to only card readers within the maximum cord length of the apparatus.

While the embodiments of the apparatus for securing and storing a payment card depicted herein are constructed of a combination of rigid polymer materials and metals, it is contemplated that alternate embodiments of the apparatus (or components thereof) may be constructed of other materials such as alloys, carbon fiber, biological materials, and other materials having sufficient rigidity/durability to withstand attempts to gain unauthorized entry into the apparatus, and having sufficient corrosion resistance properties for use in an outside environment.

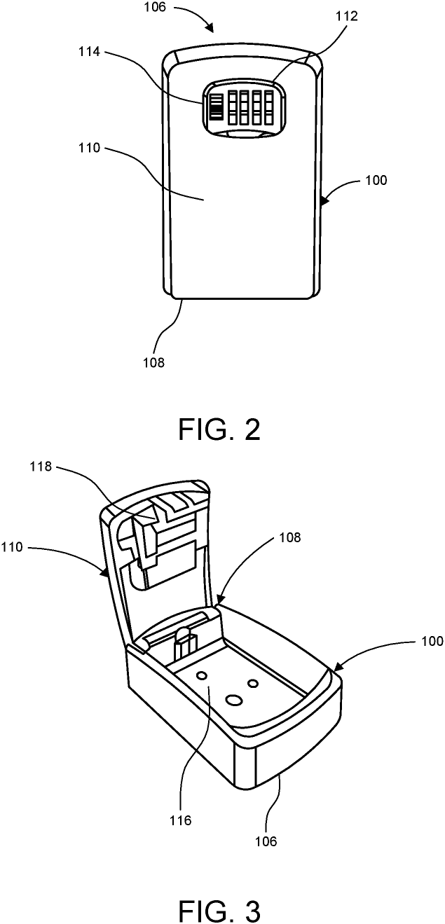

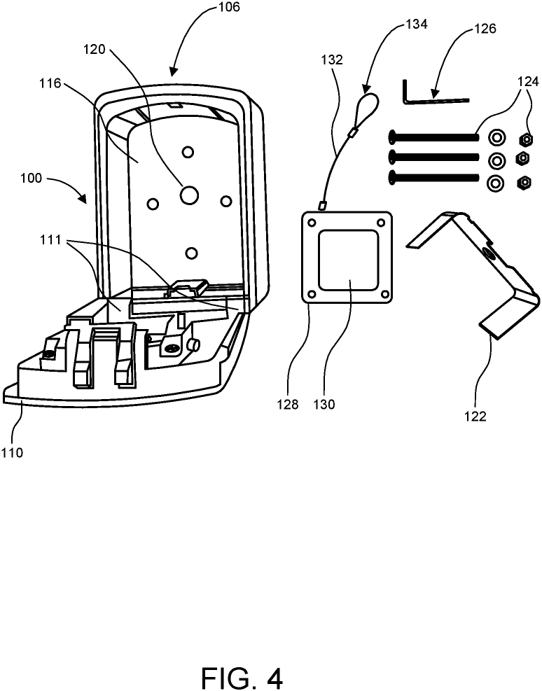

Referring now to FIG. 2, shown is a front view of the embodiment of an apparatus container body (100) for securing and storing a payment card depicted in FIG. 1, said apparatus being in a closed configuration. In one embodiment, the apparatus container body comprises a top side (106), a bottom side (108), and a front side that is an access door (110). The access door (110) in one embodiment of the apparatus is hingedly attached (see FIG. 4 at 111) to the bottom side of the apparatus container body such that the access door can pivot about a hinge to move from a locked or unlocked closed configuration (shown in FIG. 2), to an unlocked open configuration (shown in FIGS. 3-7), and vice versa. In alternate embodiments, the access door may be positioned on a side or sides of the container body other than the front side. In even further alternate embodiments, the container body may not include an access door, but instead other secure means for gaining access to the interior chamber of the container body such as, for example, a lockable sliding panel integrated into a side of the container body. In even further alternate embodiments, a slot sized and shaped to permit the passage of a payment card may be formed on a side of the container body. The apparatus in one embodiment comprises a lock mechanism having components on the interior and exterior sides of the apparatus container body, said lock mechanism allowing authorized users to lock and unlock the access door, while preventing access to the interior chamber of the apparatus by unauthorized persons. In one embodiment, a combination lock mechanism having a plurality of numbered rotary discs (112) and a lever (114) are utilized as part of a locking mechanism to control access to the interior chamber of the apparatus containing a payment card. While the embodiments of the apparatus depicted herein utilize combination lock mechanisms to lock the access door and thereby control access to the interior of the chamber, it is contemplated that all manner of other types of mechanical and electronic lock mechanisms (including, but not limited to, biometric locks, electronic keypads, IoT-enabled locks, etc.) can be utilized in alternate embodiments of the apparatus.

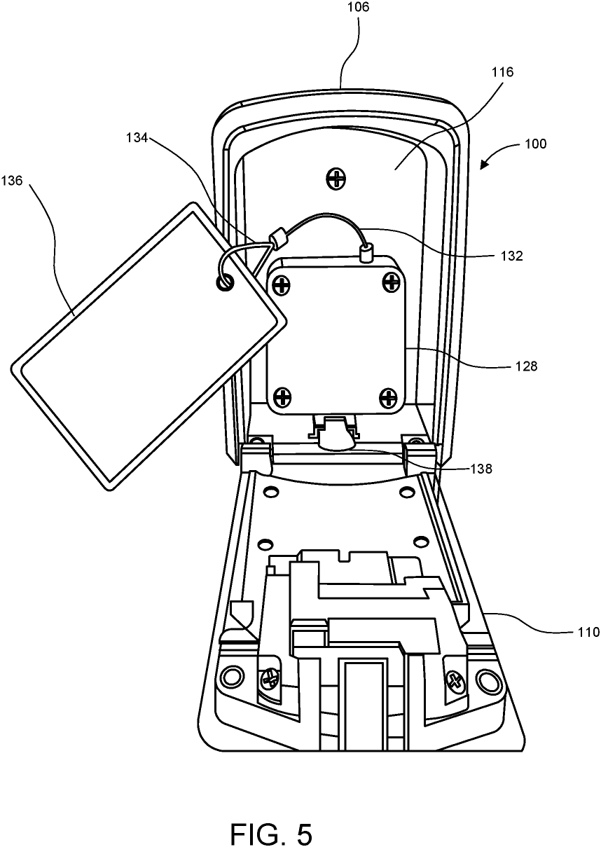

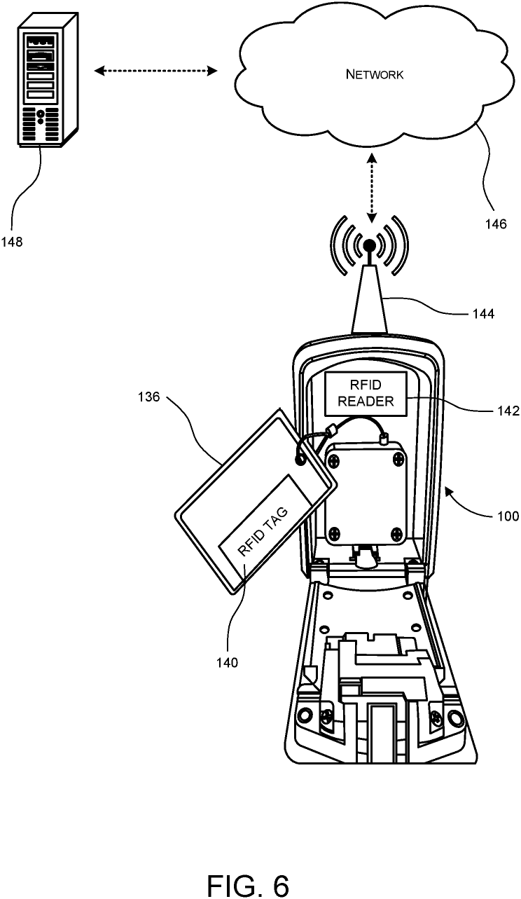

Referring now to FIG. 3, shown is a perspective view of an embodiment of an apparatus container body (100) for securing and storing a payment card depicted in FIG. 1, said apparatus container body being in an open configuration with an open access door (110). In one embodiment, the opening of the access door (110) permits a user to gain access to the interior chamber (116) of the apparatus container body which, as depicted in FIGS. 5-6, is configured to have a spool containing a retractable cord/line/cable mounted within. Interior components of the locking mechanism (118) may be mounted in one embodiment to an interior side of the access door (110), and also near the top side of the apparatus. Further, in one embodiment, the exterior dimensions of the apparatus are 10 centimeters in width, 14.2 centimeters in height, and 5.4 centimeters in thickness. In one embodiment, the interior dimensions of the apparatus are 8 centimeters in width, 11.9 centimeters in height, and 4.1 centimeters in thickness. However, it is contemplated that alternate embodiments of the apparatus may have various other exterior and/or interior dimensions.

Referring now to FIG. 4, shown is a perspective view of components of the embodiment of an apparatus container body (100) for securing and storing a payment card depicted in FIG. 3. In one embodiment, hinges (111) are used to connect the access door (110) to the bottom side of the main apparatus container body (100). However, in alternate embodiments, the access door may be connected to another side of the main apparatus container body, and connecting mechanisms other than hinges may be used to connect the access door to the main apparatus body. One or more apertures (120) may be formed, in one embodiment, on the back side of the main apparatus container body, such apertures facilitating the mounting of the apparatus container body to a vehicle with one or more fasteners, and also facilitating the mounting of a spool housing within the interior chamber of the apparatus using one or more fasteners. In one embodiment, a spool housing (128) having a spring-loaded (coil spring) retractable cord (132) is configured for mounting within the interior chamber (116) of the apparatus. The spool housing may be mounted within the interior chamber of the apparatus using one or more fasteners (124), adhesives (130), and/or other mounting means. It is contemplated that the spool housing be securely mounted within the interior chamber such that the spool housing cannot be easily dislodged from the apparatus. A length of the tether cord/line may be selected when constructing the apparatus, depending on the intended range of use of the payment card from the apparatus. In one embodiment, the spool will allow for the deployment of the cord/line to a predetermined maximum length, which in turn determines the range of use of the attached payment card. A distal end of the cord/line (132) may include a loop (134) used to connect the cord to a payment card, said payment card in one embodiment having a hole formed through the card to allow for attachment with the loop. A mounting bracket (122) may also be utilized to mount the apparatus to a vehicle via the further use of one or more fasteners (124) with the use of a fastening tool such as a hexagonal key wrench (126). While a loop (134) in the retractable cord (132) is utilized in the embodiment of the apparatus depicted herein, it is also contemplated that other various means for coupling the cord to a payment card may be utilized in alternate embodiments of the apparatus.

Referring now to FIG. 5, shown is a perspective view of an embodiment of an apparatus for securing and storing a payment card depicted in FIG. 1, said apparatus being in an open configuration, and having a payment card connected to said apparatus. In one embodiment, the spool housing (128) having a retractable cord (132) is mounted inside the interior chamber (116) of the apparatus container body (100) using a combination of threaded fasteners and adhesives. A payment card (136) is attached to the distal end of the cord containing a loop (134). The interior chamber of the apparatus must be shaped and sized to contain at least one spool and one payment card. Alternate embodiments of the apparatus may be configured to have an interior chamber shaped and sized to receive multiple spools and multiple payment cards, giving drivers multiple options of payment cards to use for authorized types of transactions. In one alternate embodiment, hook and loop fasteners may be attached to one or more sides of the payment card(s) and spool housing (or interior sides of interior chamber) to secure the payment card within the interior chamber (to prevent it from rattling around on the inside of the interior chamber as the vehicle is moving).

Referring now to FIG. 6, shown is a perspective view of an alternate embodiment of an apparatus for securing and storing a payment card depicted in FIG. 5, said apparatus being in electronic communication with a network to provide an alert if said payment card moves beyond a predetermined distance from said apparatus. In this alternate embodiment, the mechanical means of the apparatus for securing and storing a payment card are utilized in conjunction with an electronic alert system for notifying a card provider, card issuer, or other person or entity that the payment card has traveled beyond a predetermined range from the apparatus, indicating tampering with the system. In one embodiment, an RFID tag is attached to the payment card, and an RFID reader is attached to the apparatus (reader could also be mounted to the exterior or interior of the vehicle). Those of ordinary skill in the art will recognize that an RFID tag and reader can be utilized to determine when the payment card has traveled beyond the range of the reader to detect its presence. In one embodiment, a vicinity card using ISO/IEC 15693 standard at a high frequency (13.56 MHz) can be utilized in conjunction with the payment card to detect whether the card is within range (for example, within 1-1.5 meters) of the card reader. Other types of technology known in the art for use to detect proximity may also be employed in other alternate embodiments. If the card reader is unable to detect the presence of the vicinity card/payment card, a processor or microcontroller (not shown) may be configured to wirelessly transmit via an antenna (144) a signal to a network that is in turn in communication with a server or other computer monitored by the card provider or issuer, indicating that the payment card is no longer within acceptable range of the apparatus (indicating tampering and possible unauthorized use of payment card by authorized user or unauthorized person). The card provider or issuer may then take steps, both manually or automatically, to disable the payment card and/or communicate with the driver to determine the status of the payment card. This aspect of the invention provides an advantage over other prior art apparatuses for securing and storing a payment card in that it provides an electronic alert to the card provider or issuer that tampering may be occurring even if the mechanical means of securing the payment card have been compromised.

In one embodiment of the apparatus for securing and storing a payment card, the apparatus includes a hollow container body having a back side, top side, bottom side, and lateral sides, the back side having one or more apertures formed thereon. In one embodiment, the apparatus also includes a lockable door that is hingedly coupled to the container body, the lockable door configured to open to provide controlled access to an interior chamber formed within the hollow container body. In one embodiment, the apparatus also includes a tether line having a proximal end secured to a retractable spool, the spool being mounted within a spool housing, the spool housing being mounted within the interior chamber of the apparatus container body. In one embodiment, a distal end of said tether line is configured for attachment to a proximal end of a payment card. In one embodiment, the apparatus includes a payment card attached to the tether line, the payment card having at least one aperture formed through the payment card, preferably adjacent to an edge of the payment card. In one embodiment, a loop is formed on the distal end of the tether line, the loop passing through the aperture formed through the payment card. In one embodiment, the apparatus also includes a trigger mounted to the spool housing, the trigger configured to be actuated by a user to apply tension to the tether line to halt travel of the tether line. In one embodiment, the one or more apertures formed on the back side of the container body are sized and shaped to receive one or more correspondingly shaped and sized fasteners for securing the hollow container body to a vehicle. In one embodiment, the lockable door is hingedly coupled to the bottom side of the container body. In one embodiment, the apparatus also includes a plurality of rotary dials that are mounted to a front side of the lockable door, the rotary dials being connected to a locking mechanism. In one embodiment, the apparatus also includes a slidable access cover mounted on the front side of the lockable door to cover the plurality of rotary dials. In one embodiment, the apparatus also includes a radio frequency identification reader attached to the container body. In one embodiment, the apparatus also includes an antenna that is mounted to the container body and is electrically connected to the radio frequency identification reader. In one embodiment, the spool is biased to retract said tether line.

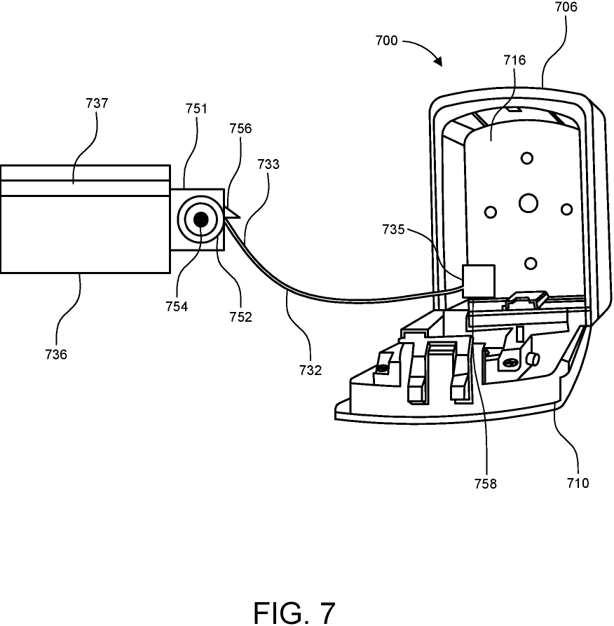

Referring now to FIG. 7, shown is a perspective view of a further alternate embodiment of an apparatus for securing and storing a payment card depicted in FIG. 5. In this alternate embodiment, a proximal end of a tether cord/line (732) is secured to an attachment point (735) on the interior chamber (716) of the apparatus container body (700), and a distal end (733) of the tether cord/line (732) is engaged to a spring-loaded spool (752) that is biased to retract the line/cord. The spool is configured to rotate about a pin that secures the spool (containing a coiled spring attached to a distal end of the cord) to a spool housing (751). The spool housing in one embodiment of the apparatus is coupled to a proximal end of a payment card (736) having a magnetic strip (737), chip (not depicted), or other means for being read by a payment card reader. In one embodiment, the spool housing may be adhesively attached to the payment card. In other embodiments, the spool housing may be fastened to the payment card. In even other embodiments, the spool housing may be integrally formed with the payment card. In one embodiment, a trigger (756) or other user-actuated braking mechanism may be attached or otherwise connected to the spool housing. In one embodiment, the trigger may be connected to the spool housing in a manner configured to permit a user to apply pressure on the trigger to slide a stop onto the cord/line to apply tension to such cord/line and thus act as a brake to halt the retraction tension on the cord/line. At least in one embodiment, the trigger and spool may be constructed in a manner identical to a tape measure having a user-actuated brake. An example of such a user-actuated lock assembly and trigger is described in U.S. Pat. No. 5,379,523, entitled “Tape Lock Mechanism,” which issued on Jan. 10, 1995, the teachings of which are incorporated by reference herein. It should be noted however, that alternate embodiments of the apparatus may utilize other types of retractable tethers having other types of user-actuated braking mechanisms.

Still referring to FIG. 7, the relocation of the spool housing with a user-actuated braking trigger to be attached to the payment card in this alternate embodiment of the apparatus provides an advantage over the prior art in that it allows a user to control the retraction/extension of the cord/line at payment card, where the user will naturally be positioned when using the payment card. While most prior art braking mechanisms involving a retractable cord (dog leash) or tape (tape measure) are positioned at the proximal end of the cord/tape, the positioning of the braking mechanism and spool on the distal end of the cord/line as configured in this embodiment of the apparatus allows for greater user control of the retraction mechanism while using a tethered payment card.

In one embodiment of the apparatus for securing and storing a payment card, the apparatus includes a hollow container body having a back side, top side, bottom side, and lateral sides, the back side having one or more apertures formed thereon. In one embodiment, the apparatus also includes a lockable door that is hingedly coupled to the container body, the lockable door being configured to open to provide controlled access to an interior chamber formed within said hollow container body. In one embodiment, the apparatus also includes a tether line having a proximal end secured to a surface within the interior chamber, the tether line having a distal end secured to a retractable spool, the spool being mounted within a spool housing, wherein the spool housing is configured for attachment to a proximal end of a payment card. In one embodiment, the apparatus also includes a trigger mounted to the spool housing, the trigger configured to be actuated by a user to apply tension to the tether line to halt travel of the tether line. In one embodiment, the one or more apertures formed on the back side of the container body are sized and shaped to receive one or more correspondingly shaped and sized fasteners for securing the hollow container body to a vehicle. In one embodiment, the lockable door is hingedly coupled to the bottom side of the container body. In one embodiment, the apparatus also includes a plurality of rotary dials that are mounted to a front side of the lockable door, the rotary dials being connected to a locking mechanism. In one embodiment, the apparatus also includes a slidable access cover mounted on the front side of the lockable door to cover the plurality of rotary dials. In one embodiment, the apparatus also includes a radio frequency identification reader attached to the container body. In one embodiment, the apparatus also includes an antenna that is mounted to the container body and is electrically connected to the radio frequency identification reader. In one embodiment, the spool is biased to retract said tether line.

The invention may be embodied in other specific forms without departing from the spirit or essential characteristics thereof. The present embodiments are therefore to be considered in all respects as illustrative and not restrictive. All changes that come within the meaning and range of equivalency of the claims are embraced therein.

I claim:

1. An apparatus for securing and storing a payment card, the apparatus comprising:
a hollow container body having a back side, top side, bottom side, and lateral sides, said back side having one or more apertures formed thereon;
a lockable door that is hingedly coupled to said container body, said lockable door configured to open to provide controlled access to an interior chamber formed within said hollow container body;
a tether line having a proximal end secured to a surface within said interior chamber, said tether line having a distal end secured to a retractable spool, said spool being mounted within a spool housing,
wherein said spool housing is configured for attachment to a proximal end of a payment card.

2. The apparatus for securing and storing a payment card of claim 1, further comprising a trigger mounted to said spool housing configured to be actuated by a user to apply tension to said tether line to halt travel of said tether line.

3. The apparatus for securing and storing a payment card of claim 2, wherein said one or more apertures are sized and shaped to receive one or more correspondingly shaped and sized fasteners for securing said hollow container body to a vehicle.

4. The apparatus for securing and storing a payment card of claim 3, wherein said lockable door is hingedly coupled to said bottom side of said container body.

5. The apparatus for securing and storing a payment card of claim 4, wherein a plurality of rotary dials is mounted to a front side of said lockable door, said rotary dials being connected to a locking mechanism.

6. The apparatus for securing and storing a payment card of claim 5, further comprising a slidable access cover mounted on said front side of said lockable door to cover said plurality of rotary dials.

7. The apparatus for securing and storing a payment card of claim 1, further comprising a radio frequency identification reader attached to said container body.

8. The apparatus for securing and storing a payment card of claim 7, further comprising an antenna that is electrically connected to said radio frequency identification reader.

9. The apparatus for securing and storing a payment card of claim 1, wherein said spool is biased to retract said tether line.

10. An apparatus for securing and storing a payment card, the apparatus comprising:
a hollow container body having a back side, top side, bottom side, and lateral sides, said back side having one or more apertures formed thereon;
a lockable door that is hingedly coupled to said container body, said lockable door configured to open to provide controlled access to an interior chamber formed within said hollow container body;
a tether line having a proximal end secured to a retractable spool, said spool being mounted within a spool housing, said spool housing being mounted within said interior chamber;
wherein a distal end of said tether line is configured for attachment to a proximal end of a payment card.

11. The apparatus for securing and storing a payment card of claim 10, further comprising a trigger mounted to said spool housing configured to be actuated by a user to apply tension to said tether line to halt travel of said tether line.

12. The apparatus for securing and storing a payment card of claim 11, wherein said one or more apertures are sized and shaped to receive one or more correspondingly shaped and sized fasteners for securing said hollow container body to a vehicle.

13. The apparatus for securing and storing a payment card of claim 12, wherein said lockable door is hingedly coupled to said bottom side of said container body.

14. The apparatus for securing and storing a payment card of claim 13, wherein a plurality of rotary dials is mounted to a front side of said lockable door, said rotary dials being connected to a locking mechanism.

15. The apparatus for securing and storing a payment card of claim 14, further comprising a slidable access cover mounted on said front side of said lockable door to cover said plurality of rotary dials.

16. The apparatus for securing and storing a payment card of claim 10, further comprising a radio frequency identification reader attached to said container body.

17. The apparatus for securing and storing a payment card of claim 16, further comprising an antenna that is electrically connected to said radio frequency identification reader.

18. The apparatus for securing and storing a payment card of claim 10, wherein said spool is biased to retract said tether line.
